(19) United States
(12) Patent Application Publication
(10) Pub. No.: US 2006/0161698 A1
(43) Pub. Date: Jul. 20, 2006

(54) Architecture for accessing an external memory

(76) Inventors: Chun-Fu Shen, Chung-Ho City (TW); Ju-Lung Fann, Chung-Ho City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/126,357

(22) Filed: May 11, 2005

(30) Foreign Application Priority Data
Jan. 18, 2005 (TW) 094101419

(51) Int. Cl. G06F 5/00; G06F 13/40

(52) U.S. Cl. 710/52; 710/307

(57) ABSTRACT

Provided is an external memory accessing architecture for use with IC comprising a first bus connected to an external memory and having n-bit data width; a first buffer unit of k serially connected first buffers each having n-bit data width, a first one of the first buffers connected to the external memory via the first bus; a second buffer unit comprising a second buffer having k*n-bit data width, the second buffer connected to the first buffers; a second bus connected to the second buffer for transferring k*n-bit data; an output unit connected to the second buffer unit and comprising a multiplexer; and a controller connected to the output unit, the second bus, and the external memory respectively such that the controller is able to read data from the external memory or transfer data thereto via the second bus and at least one control signal in higher transfer rate.

### BACKGROUND OF THE INVENTION

1. Field of Invention

The proposed invention relates to memory access architecture, especially to the architecture about accessing an external memory in modern chip design with increased data rate by adopting two buffer units.

2. Description of Related Art

It is widely known that memory bandwidth is the most critical part to image quality in today's video processing technologies. To increase the data transfer rate between a control chip and external memory, double data rate memory is widely adopted. Unlike traditional SDRAM (synchronous dynamic random access memory) which accesses only one data per clock cycle, double data rate memory is able to access two data per clock cycle. Thus, it is possible to increase the memory bandwidth by using this kind of external memory.

Conventionally, data transfer rate between a control chip and external memory is increased by using a faster system operating frequency as shown in FIG. 1 in which a prior architecture for controlling reading and writing between a control chip and an external memory is depicted. For increasing data transfer rate between the control chip and the external memory, the architecture increases internal frequency of the control chip by k times rather than increasing bus width. As a result, data transfer rate is increased by k times. For an external memory implemented as a double data rate memory and having an operating frequency of 1 MHz (i.e., two data transfer operations per clock cycle), the operating frequency of the associated control chip is 2 MHz. In view of current technology, however, there are many restrictions and difficulties in increasing the internal frequency of a control chip. For instance, faster internal frequency of a control chip will inevitably increase chip size and power consumption, complicate the fabrication, decrease the yield rate, and raise the manufacturing cost.

Another conventional technique of increasing data transfer rate between a control chip and an external memory is done by increasing bus width as shown in FIG. 2 in which another prior architecture for controlling reading and writing between a control chip and an external memory is depicted. The architecture increases data width of a bus connected between the control chip and the external memory by k times rather than increasing the internal frequency of the control chip so as to increase data transfer rate between the control chip and the external memory. As a result, data transfer rate is increased by k times. However, increase of bus width will also increase the number of IO pins of the control chip package. As a result, not only internal layout area of the control chip is increased but also external circuit layout of the control chip is complicated. Further, the increase of the number of pins of the control chip connected to the bus will induce some problems such as cross talk, synchronization, etc.

Both prior art techniques shown in FIGS. 1 and 2 not only decrease performance and reliability of control chip but also greatly increase the manufacturing cost. This is rather undesirable. Thus, it is desirable to provide a novel architecture for increasing data transfer rate between a control chip and an external memory with reduced manufacturing cost in order to overcome the inadequacies of the prior art.

### SUMMARY OF THE INVENTION

It is therefore an object of the present invention to provide architecture for accessing external memory with increased data rate without increasing internal frequency of a control chip and IO bus width of an external bus.

To achieve the above and other objects, the present invention provides an architecture for accessing external memory for use with IC, comprising a first bus connected to the external memory and having n-bit data width; a first buffer unit comprising k first buffers each having n-bit data width wherein the first one of the first buffers is connected to the external memory via the first bus, remaining ones are serially connected to the first one of the first buffers, and k is an integer larger than zero; a second buffer unit comprising a second buffer having k*n-bit data width wherein the second buffer is connected to the first buffers; a second bus connected to the second buffer which is able to transfer k*n-bit data; an output unit connected to the second buffer unit and comprising a multiplexer; and a controller connected to the output unit, the second bus, and the external memory respectively such that the controller is able to read data from the external memory or transfer data thereto via the second bus and at least one control signal.

Preferably, a first n-bit data is stored in the first one of the first buffers when a control chip reads p*n-bit data from the external memory.

Preferably, in response to storing the first n-bit data in the first one of the first buffers, the first n-bit data is transferred to the second one of the first buffers, a second n-bit data is transferred to the first one of the first buffers, and remaining data is sequentially transferred to the serially connected first buffers.

Preferably, in response to storing the p*n-bit data in the p first buffers, data in the p first buffers is transferred to the second buffer.

Preferably, data in the p first buffers is transferred to the second buffer in parallel at one time.

Preferably, the controller is adapted to read the p*n-bit data via the second bus at one time.

Preferably, the external memory is adapted to send p*n-bit data per clock cycle, where p is an integer larger than zero.

Preferably, the output unit further comprises an output buffer connected to the external memory via the multiplexer.

Preferably, the external memory is a double data rate memory, the output buffer is a register, and each of the first and second buffers is a register.

Preferably, the controller transfers k*n-bit data to the second buffer when writing k*n-bit data into the external memory.

Preferably, the transfer of the k*n-bit data to the second buffer is done in parallel in one second clock cycle.

Preferably, the multiplexer selects n-bit data from the second buffer prior to storing the same in the output buffer, and the output buffer transfers the same to the external memory as output.

The above and other objects, features and advantages of the present invention will become apparent from the following detailed description taken with the accompanying drawings.

### BRIEF DESCRIPTION OF THE DRAWINGS

FIG. 1 is a block diagram depicting a conventional architecture for increasing data transfer rate between a control chip and external memory;

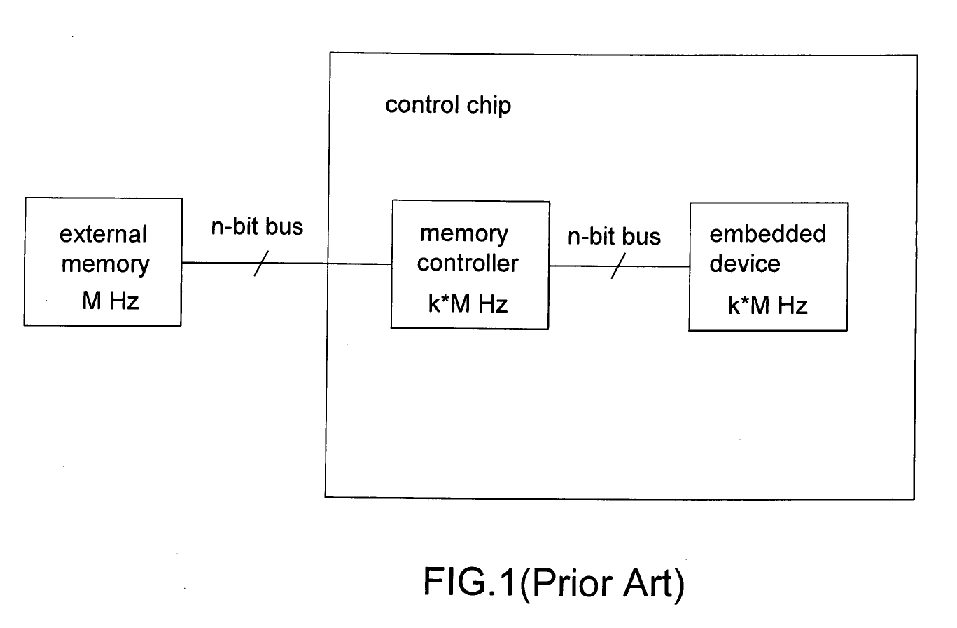

FIG. 2 is a block diagram depicting another conventional architecture for increasing data transfer rate between a control chip and external memory;

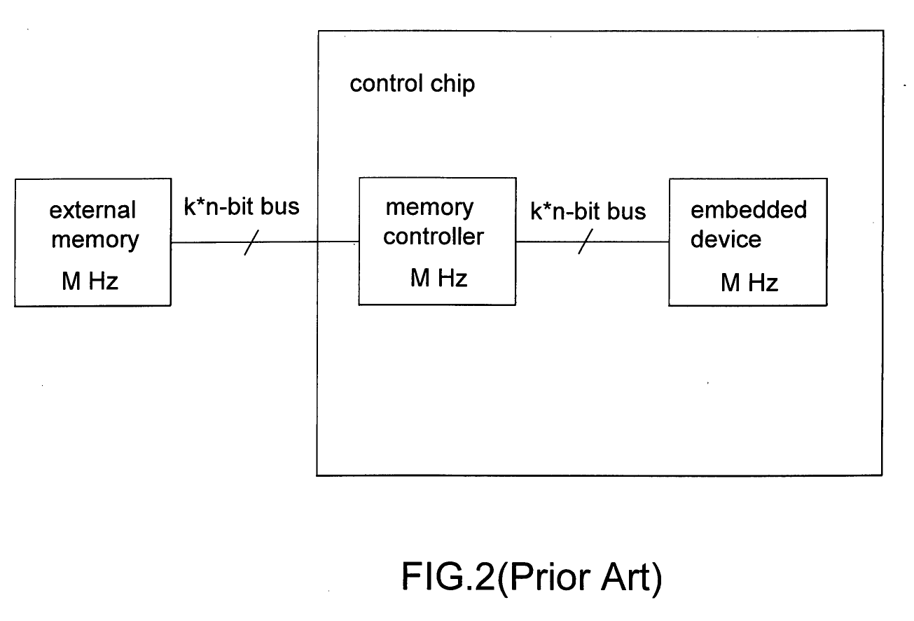

FIG. 3 is a block diagram depicting an architecture for increasing data transfer rate between a control chip and external memory in a reading and writing operation according to a preferred embodiment of the invention;

FIG. 4 is a detailed block diagram of the architecture shown in FIG. 3; and

FIG. 5 depicts signal waveforms of certain components including the external memory, the first bus, the second bus, and the first and second clock.

### DETAILED DESCRIPTION OF THE INVENTION

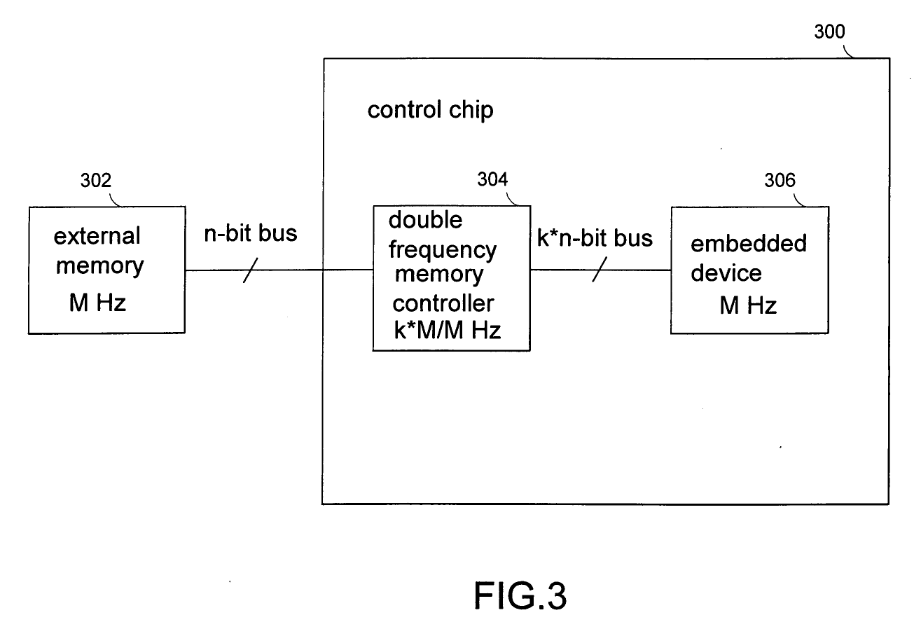

Referring to FIG. 3, there is shown an architecture for reading data from an external memory or writing data into the external memory for use with IC in accordance with a preferred embodiment of the invention. The architecture comprises a control chip 300, an external memory 302, a dual frequency memory controller 304, and a predetermined embedded device 306. The control chip 300 is electrically connected to the dual frequency memory controller 304 via a bus of n-bit data width. The dual frequency memory controller 304 is electrically connected to the embedded device 306 via a bus of k*n-bit data width. The external memory 302 is able to transfer n-bit data k times per clock cycle, where n and k are integers larger than zero.

For instance, a bus with eight data lines is interconnected the external memory 302 and the dual frequency memory controller 304. The external memory 302 has an operating frequency of 1 MHz and is able to transfer 16-bit data per clock cycle. Accordingly, the dual frequency memory controller 304 must have an operating frequency of 2 MHz to receive 16-bit data via the eight data lines during the same clock cycle. Next, the dual frequency memory controller 304 transfers the received 16-bit data to the embedded device 306 for further processing via 16 internal data lines in 1 MHz. That is, eight data lines are involved in transferring data from the external memory 302 to the dual frequency memory controller 304 and advantageously 16 data lines are involved in transferring same data from the dual frequency memory controller 304 to the embedded device 306 as controlled by the control chip 300.

Moreover, as to data rate, data transferred between the external memory 302 and the dual frequency memory controller 304 is at a rate of 8*2 Mbps and data transferred between the double frequency memory controller 304 and the embedded device 306 is at a rate of 16 Mbps. Thus, the invention is able to increase data rate by using faster operating frequency in the dual frequency memory controller 304 without increasing bit width of an external bus. And the layout area of a dual frequency memory controller 304 is only about 3% to 5% of the total layout area of today's chip design technology. In other words, the additional manufacturing cost is relatively low.

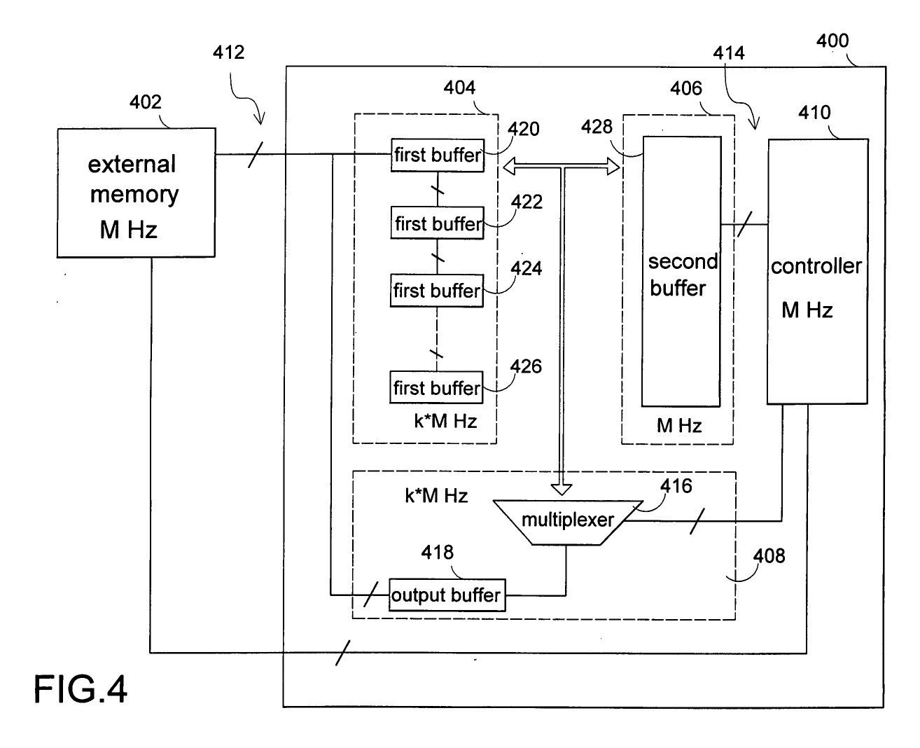

Referring to FIG. 4, it shows a detailed block diagram of the architecture. It comprises a control chip 400, an external memory 402, a first buffer unit 404, a second buffer unit 406, an output unit 408, a controller 410, a first bus 412, and a second bus 414. The first buffer unit 404 comprises first buffers 420, 422, 424, and 426. The second buffer unit 406 comprises a second buffer 428. The output unit 408 comprises a multiplexer 416 and an output buffer 418. The external memory 402 is able to transfer p*n-bit data per clock cycle, where p is an integer larger than zero. In the embodiment, the external memory is implemented as a double data rate memory and each of the first buffers 420, 422, 424, and 426, the second buffer 428, and the output buffer 418 is implemented as a register.

The first bus 412 is connected to the external memory 402. The first bus 412 has n-bit data width. The first buffer unit 406 has k first buffers each having n-bit data width. The first bus 412 is interconnected the first buffer 420 and the external memory 402. The first buffers 422, 424, and 426 are serially connected to the first buffer 402. In the embodiment, k is an integer larger than zero and is equal to p. Moreover, the second buffer unit 406 comprises a second buffer 428 having k*n-bit data width. The second buffer 428 is connected to all first buffers including first buffers 420, 422, 424, and 426.

Also, the second bus 414 is connected to the second buffer 428 having k*n-bit data width. Thus, the second buffer 428 is able to transfer k*n-bit data via the second bus 414. The output unit 408 is connected to the second buffer unit 406. The controller 410 is connected to the output unit 408, the second bus 414, and the external memory 402 respectively. The controller 410 is able to read data from the external memory 402 or transfer data thereto via the second bus 414 and at least one control signal.

The controller 410 sends a control signal to the external memory 402 when the control chip 400 reads p*n-bit data from the external memory 402. Next, the external memory 402 transfers p*n-bit data to the control chip 400 as output. In a first clock cycle, first n-bit data is stored in the first buffer 402. In the next first clock cycle, the first n-bit data is transferred to the first buffer 422 (i.e., the second one) and second n-bit data is transferred to the first buffer 420 (i.e., the first one). Likewise, remaining data can be sequentially transferred to the serially connected first buffers. That is, the controller 410 stores n-bit data in the first buffer unit 404 p times in one clock cycle (e.g., external memory clock cycle) in a manner the same as above. Thereafter, data stored in p first buffers is transferred to the second buffer 428 in parallel at one time.

Note that it is assumed that each first buffer has a capacity of n bits and k is equal to p. Data stored in the k first buffers is automatically transferred to the second buffer 428 if the k first buffers are full of data. Next, the controller 410 reads data from the second buffer 428 via the second bus 414 at one time. That is, the controller 410 can read p*n-bit data from the second buffer 428 at one time.

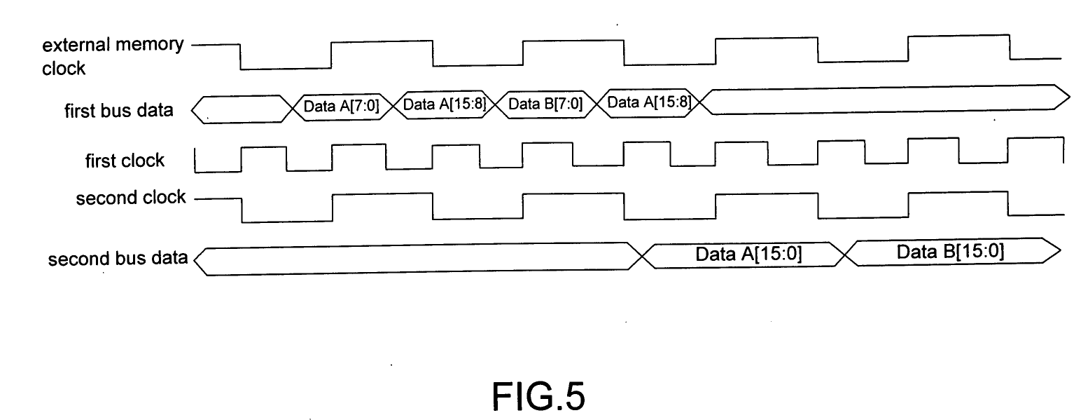

Referring to FIG. 5 in conjunction with FIG. 4, it depicts signal waveforms of the external memory 402, the first bus 412, the second bus 414, and the first and second clock. It is assumed that n is equal to 8 and both k and p are equal to 2. These waveforms aim at describing timing relationship among the above components when the controller 410 is reading 16-bit data from the external memory 402.

For writing k*n-bit data into the external memory 402, the controller 410 sends k*n-bit data to the second buffer 428 in parallel in one second clock cycle. Next, the controller 410 sends a control signal to the multiplexer 416. Next, the multiplexer 416 selects one of the k n-bit data from the second buffer 428 in one first clock cycle and store it to the output buffer 418. In the next first clock cycle, the output buffer 418 transfers data to the external memory 402 as output. The second buffer unit 406 operates at a frequency of 1 MHz, the first buffer unit 404 operates at a frequency of k MHz, and each of the controller 410 and the output unit 408 operates at a frequency of 1 MHz. In view of the above, it is clear that only the first buffer unit 404 operates at higher frequency.

In brief, the invention is able to increase data rate without increasing internal frequency of the control chip and bus width, and thus improve the performance of low speed control chip without increasing the manufacturing cost.

While the invention herein disclosed has been described by means of specific embodiments, numerous modifications and variations could be made thereto by those skilled in the art without departing from the scope and spirit of the invention set forth in the claims.

What is claimed is:

1. An architecture for accessing an external memory for use with IC, comprising:
a first bus connected to the external memory and having n-bit data width;
a first buffer unit comprising k first buffers each having n-bit data width wherein the first one of the first buffers is connected to the external memory via the first bus, remaining ones of the first buffers are serially connected to the first one of the first buffers, and k is an integer larger than zero;
a second buffer unit comprising a second buffer having k*n-bit data width wherein the second buffer is connected to the first buffers;
a second bus connected to the second buffer being able to transfer k*n-bit data;
an output unit connected to the second buffer unit and comprising a multiplexer; and
a controller connected to the output unit, the second bus, and the external memory respectively such that the controller is able to read data from the external memory or transfer data thereto via the second bus and at least one control signal.

2. The architecture of claim 1, wherein the first n-bit data is stored in the first one of the first buffers when a control chip reads p*n-bit data from the external memory.

3. The architecture of claim 2, wherein in response to storing the first n-bit data in the first one of the first buffers, the first n-bit data is transferred to the second one of the first buffers, a second n-bit data is transferred to the first one of the first buffers, and remaining data is sequentially transferred to the serially connected first buffers.

4. The architecture of claim 2, wherein the p*n-bit data is stored in p ones of the first buffers in p first clock cycles, where p is an integer larger than zero.

5. The architecture of claim 4, wherein in response to storing the p*n-bit data in the p ones of the first buffers, data in the p ones of the first buffers is transferred to the second buffer.

6. The architecture of claim 5, wherein data in the p ones of the first buffers is transferred to the second buffer in parallel at one time.

7. The architecture of claim 5, wherein the controller is adapted to read the p*n-bit data via the second bus at one time.

8. The architecture of claim 1, wherein the external memory is adapted to send p*n-bit data per clock cycle, where p is an integer larger than zero.

9. The architecture of claim 1, wherein the external memory is a double data rate memory.

10. The architecture of claim 1, wherein each of the first buffers is a register.

11. The architecture of claim 1, wherein each of the second buffers is a register.

12. The architecture of claim 1, wherein the output unit further comprises an output buffer connected to the external memory via the multiplexer.

13. The architecture of claim 12, wherein the output buffer is a register.

14. The architecture of claim 1, wherein the controller transfers k*n-bit data to the second buffer when writing k*n-bit data into the external memory.

15. The architecture of claim 14, wherein the transfer of the k*n-bit data to the second buffer is done in parallel in one second clock cycle.

16. The architecture of claim 15, wherein the multiplexer selects n-bit data from the second buffer prior to storing the same in the output buffer, and the output buffer transfers the same to the external memory as output.
